(19) United States
(12) Patent Application Publication
(10) Pub. No.: US 2022/0268437 A1
(43) Pub. Date: Aug. 25, 2022

(54) UNIVERSAL MOUNTING BRACKET DEVICE

(71) Applicant: Design Trifecta, LLC, Indianola, WA (US)

(72) Inventors: Henry Leggett, Indianola, WA (US); Sara Leggett, Indianola, WA (US)

(21) Appl. No.: 17/181,319

(22) Filed: Feb. 22, 2021

(51) Int. Cl. F21V 33/00; A47G 1/16; A47G 29/087; B25H 3/00; F21V 23/04; F21V 29/83

(52) U.S. Cl. CPC F21V 33/0028; A47G 1/16; A47G 29/087; B25H 3/00; F21V 23/04; F21V 29/83; A47G 2001/1673; F21Y 2115/10

(57) ABSTRACT

A universal mounting bracket device displays objects from a surface by allowing a user to change the displayed object with ease. The device can display heavy objects, or objects that are interacted with frequently. The device also contains the means for backlighting the object being displayed.

### FIELD OF THE INVENTION

The present disclosure relates to a wall mounting bracket device and, more specifically, a universal wall mounting bracket device that allows a user to affix the back portion of the bracket to a surface and the front portion to an object which allows the user to then easily slide the front portion, with the object attached, onto the back portion to be displayed.

### BACKGROUND OF THE INVENTION

Bracket devices to display or hang artwork, tools, utensils, or valuable objects are widely used. Such devices are often utilized to hang objects on walls or other surfaces. In particular, these devices are also often used to display objects of that attention is desired to be drawn to. These Such devices are often built onto or permanently affixed to the displayed object. Typically, such devices are commonly fabricated of metallic materials that are affixed to the back of the object to be displayed. These devices commonly have a saw tooth pattern on one side or circular openings. To then hang the object on a surface a nail or screw is placed into the surface and the object is hung by either hooking the head of the nail or screw in one of the notches in the saw tooth pattern or placing the head of the nail or screw through one of the circular openings in the bracket device. These types of devices are deficient at least because they are not capable of securely hanging heavy objects or objects that are bumped or jarred frequently.

Other hanging devices comprise a string or wire that is affixed to the back of the object and a screw or nail is placed into the surface and the object is hung by hooking the string or wire onto the head of the nail or screw. These devices are also deficient at least because they are not capable of securely hanging heavy objects to a surface. Further these devices are deficient at least because they cannot be used for different object. In order to change the object a new device must be affixed to the back of the object. Hook and loop devices suffer from the same problems as aforementioned devices.

Some bracket devices are commonly used in conjunction with a separate light fixture that is either affixed to the same surface that the object is being displayed from or from an abutting surface. These light fixtures are typically configured such that the light hits the front of the object being displayed. Typically, the bracket devices are not connected to the light fixtures, and they are instead affixed on to the surface. These types of bracket devices are deficient at least because they require an additional light fixture, which is not part of the bracket device, to provide light to the object being displayed.

For the foregoing reasons, there is a need for a bracket device that allows for an object to be safely secured to a surface and is configured to be used for different objects.

### SUMMARY OF THE INVENTION

The present disclosure, in its many embodiments, overcomes these and other deficiencies of the current products by providing a universal bracket device that allows for numerous types of objects to be safely and securely displayed on a surface and that also allows for the object being displayed to be changed out for another object that also may include backlighting.

In one embodiment, a universal mounting bracket device comprises a wall bracket that comprises a top surface, a bottom surface, a front side, and a back side, wherein the wall bracket is configured to be affixed to a surface. In one embodiment, the wall bracket comprises a plurality of wall bracket holes, and the wall bracket comprises an on/off switch located on the front side of the wall bracket. The universal mounting bracket device further comprises a mounting plate with a top side and a bottom side, wherein the mounting plate is configured to allow an object to be affixed to the top side, and the mounting plate comprises a plurality of mounting plate holes, a plurality of mounting plate clips protruding from the top surface of the wall bracket and a plurality of mounting plate slides protruding from the bottom side of the mounting plate.

In one embodiment, the plurality of mounting plate clips and the plurality of mounting plate slides are configured to allow the mounting plate to affix to the wall bracket. In one embodiment, the device comprises an internal power source housing protruding from the bottom surface of the wall bracket and is open on the top surface of the wall bracket; a plurality of light housing tabs affixed along the edges of the bottom surface of the wall bracket, wherein the plurality of light housing tabs are configured to hold in place a strip of LED lighting to provide back lighting to an object being displayed. In one exemplary embodiment, the strip of LED lighting is powered by an internal power source and the internal power source is affixed inside of the internal power source housing.

In a further embodiment, a universal mounting bracket comprises a rigid material selected from the group consisting of plastic, rubber, silicone, metal, and any combination thereof.

In still another embodiment, the plurality of mounting plate clips are located at each corner of the wall bracket.

In a further embodiment, a plurality of mounting plate slides are located at each corner of the mounting plate.

In an embodiment, the plurality of mounting plate clips are configured to be open at one side and closed on the opposite side such that when the mounting plate is slid onto the wall bracket the wall mounting plate can only be slid on or off of the wall bracket in one direction.

In another embodiment, the on/off switch is selected from the group consisting of a toggle switch, a slide switch, a rocker switch, and a push button switch.

In one embodiment, the wall bracket comprises a plurality of vents configured to allow for heat dissipation from the strip of LED lighting.

In still another embodiment, the strip of LED lighting is capable of being powered by an internal power source or an external power source.

In a further embodiment, the mounting plate comprises a plurality of support tabs protruding from the bottom side of the mounting plate to prevent the bottom side of the mounting plate from coming into contact with the top surface of the wall bracket.

In yet another embodiment, the mounting plate further comprises at least one support tab protruding from the bottom side of the mounting plate.

In another embodiment, a universal mounting bracket device comprises a wall bracket with a top surface, a bottom surface, a front side, and a back side. In an embodiment, the wall bracket is configured to be affixed to a surface, and the wall bracket comprises a plurality of wall bracket holes. In an embodiment, the universal mounting bracket device further comprises a mounting plate with a top side and a bottom side, wherein the mounting plate is configured to allow an object to be affixed to the top side. The mounting plate further comprises a plurality of mounting plate holes. The mounting bracket device further comprises a plurality of mounting plate clips protruding from the top surface of the wall bracket, wherein the plurality of mounting plate clips are located at each corner of the wall bracket; a plurality of mounting plate slides protruding from the bottom side of the mounting plate, wherein the plurality of mounting plate slides are located at each corner of the mounting plate; wherein the plurality of mounting plate clips and the plurality of mounting plate slides are configured to allow the mounting plate to affix to the wall bracket. In another embodiment, the universal mounting bracket device further comprises a plurality of light housing tabs along the edges of the bottom surface of the wall bracket, and wherein the plurality of light housing tabs are configured to hold in place a strip of LED lighting to provide back lighting to an object being displayed. In still another embodiment, the strip of LED lighting is powered by an external power source.

In an embodiment, the universal mounting bracket comprises a rigid material selected from the group consisting of plastic, rubber, silicone, metal, and any combination thereof.

In a further embodiment, the plurality of mounting plate clips are configured to be open at one side and closed on the opposite side such that when the mounting plate may only be slid on or off of the wall bracket in one direction.

In one embodiment, the wall bracket comprises an on/off switch located on the front side of the wall bracket.

In another embodiment, the on/off switch is selected from the group consisting of a toggle switch, a slide switch, a rocker switch, or a push button switch.

In yet another embodiment, the wall bracket comprises a plurality of vents configured to allow for heat dissipation from the strip of LED lighting.

In one embodiment, the strip of LED lighting is capable of being powered by an internal power source or an external power source.

In an exemplary embodiment, the mounting plate comprises a plurality of support tabs protruding from the bottom side of the mounting plate that prevent the bottom side of the mounting plate from coming into contact with the top surface of the wall bracket.

In an embodiment, the mounting plate comprises at least one support tab protruding from the bottom side of the mounting plate.

In still another embodiment, a method for displaying an object on a surface comprises affixing a wall bracket to a surface via a plurality of reinforced wall bracket holes, wherein the wall bracket comprises a top surface and a bottom surface; a plurality of light housing tabs located on the bottom surface of the wall bracket configured to affix a strip of LED lighting on the bottom surface of the wall bracket; a plurality of vents located along the edges of the wall bracket configured to dissipate heat caused by the strip of LED lighting; a plurality of mounting plate clips protruding from the bottom surface and wherein the plurality of mounting plate clips are open at one side and closed at the other side; affixing an object to a mounting plate by via a plurality of mounting plate holes; wherein the mounting plate comprises a top side and a bottom side; a plurality of mounting plate slides protruding from the bottom side. In one embodiment, the last step comprises sliding the mounting plate onto the wall bracket via a plurality of mounting plate slides and a plurality of mounting plate clips.

According to exemplary embodiments of the present disclosure, the universal mounting bracket device comprises a wall bracket with a top surface and a bottom surface, a front side and a back side, a plurality of mounting plate clips protruding from the top surface of the wall bracket, an internal power source housing protruding from the bottom surface of the wall bracket and is open on the top surface of the wall bracket, a plurality of light housing tabs affixed along the edges of the bottom surface of the wall bracket, a plurality of reinforced wall bracket holes to allow the user to affix the wall bracket to a surface, a plurality of vents, and an on/off switch located on the frontside of the wall bracket; and a mounting plate with a top side and a bottom side, a plurality of mounting plate slides protruding from the bottom side of the mounting plate, at least one support tab protruding from the bottom side of the mounting plate, wherein the plurality of mounting plate slides and the plurality of mounting plate clips are configured to allow a user to slide the mounting plate on and off of the wall bracket, and an on/off switch located on the front side of the wall bracket. The mounting plate is capable of having an object affixed to the top side via screws, nails, hook-and-loop tape, glue, or other means for affixing. The wall bracket is capable of being affixed to a surface via screws, nails, or other similar means for affixing. The mounting plate can then be easily slid onto and attached to the mounting bracket via the plurality of mounting plate clips and plurality of mounting plate slides, thereby allowing the object affixed to the mounting plate to be displayed on the surface.

In another exemplary embodiment, the universal mounting bracket device comprises a wall bracket with a top surface and a bottom surface, a front side and a back side, a plurality of mounting plate clips protruding from the top surface of the wall bracket, an external power source, a plurality of light housing tabs affixed along the edges of the bottom surface of the wall bracket, a plurality of reinforced wall bracket holes to allow the user to affix the wall bracket to a surface; and a mounting plate with a top side and a bottom side, a plurality of mounting plate holes to allow the user to affix the mounting plate to an object, a plurality of mounting plate slides protruding from the bottom side of the mounting plate, at least one support tab protruding from the bottom side of the mounting plate, wherein the plurality of mounting plate slides and the plurality of mounting plate clips are configured to allow a user to slide the mounting plate on and off of the wall bracket, and an on/off switch located on the front side of the wall bracket.

In another exemplary embodiment, the universal mounting bracket device comprises a translucent material to allow for the strip of LED lighting, affixed to the bottom surface of the wall bracket via the plurality of light housing tabs, to shine through the material. The translucent material allows for the object being displayed to be backlit by the strip of LED lighting.

In another exemplary embodiment, the plurality of mounting plate clips are configured to be open at one end and closed on the opposite side such that the mounting plate may only be slid on or off of the wall bracket in one direction.

### BRIEF DESCRIPTION OF THE DRAWINGS

Embodiments of the invention will now be described, by way of example only, with reference to the accompanying figures.

FIG. 1 illustrates an isometric top view of an exemplary embodiment of a universal mounting bracket device wherein the mounting plate is fully engaged to the wall bracket in accordance with the principles of the present invention.

FIG. 2 illustrates an isometric top view of an exemplary embodiment of a universal mounting bracket device wherein the mounting plate is partially engaged to the wall bracket in accordance with the principles of the present invention.

FIG. 3 illustrates an isometric top view of an exemplary embodiment of a universal mounting bracket device wherein the mounting plate is fully disengaged from the wall bracket in accordance with the principles of the present invention.

FIG. 4 illustrates an isometric bottom view of an exemplary embodiment of a universal mounting bracket device wherein the mounting plate is fully disengaged from the wall bracket in accordance with the principles of the present invention.

FIG. 5A illustrates a back view of an exemplary embodiment of a universal mounting bracket device wherein the mounting plate is fully engaged to the wall bracket in accordance with the principles of the present invention.

FIG. 5B illustrates a front view of an exemplary embodiment of a universal mounting bracket device wherein the mounting plate is fully engaged to the wall bracket in accordance with the principles of the present invention.

FIG. 6 illustrates a top view of an exemplary embodiment of the wall bracket in accordance with the principles of the present invention.

FIG. 7 illustrates a bottom view of an exemplary embodiment of the wall bracket in accordance with the principles of the present invention.

FIG. 8 illustrates an isometric top view of an exemplary embodiment of the wall bracket containing an internal power source in accordance with the principles of the present invention.

FIG. 9 illustrates a side view of an exemplary embodiment of the wall bracket in accordance with the principles of the present invention.

FIG. 10A illustrates a back view of an exemplary embodiment of the wall bracket in accordance with the principles of the present invention.

FIG. 10B illustrates a front view of an exemplary embodiment of the wall bracket in accordance with the principles of the present invention.

FIG. 11 illustrates a top view of an exemplary embodiment of the mounting plate in accordance with the principles of the present invention.

FIG. 12 illustrates a side view of an exemplary embodiment of the mounting plate in accordance with the principles of the present invention.

FIG. 13 illustrates a bottom view of an exemplary embodiment of the mounting plate in accordance with the principles of the present invention.

FIG. 14 illustrates a front and back view of an exemplary embodiment of the mounting plate wherein the mounting plate is removed from the wall bracket in accordance with the principles of the present invention.

### DETAILED DESCRIPTION OF THE INVENTION

The following detailed description is merely exemplary in nature and does not limit the disclosure or the application and uses of the invention. As used herein, the word “exemplary” means “serving as an example, instance, or illustration.” Thus, any embodiment described herein as “exemplary” is not necessarily to be construed as preferred or advantageous over other embodiments. Furthermore, there is no intention to be bound by any expressed or implied theory presented in the preceding technical field, background, brief summary, or the following

### DETAILED DESCRIPTION

In this description, reference is made to the figures, wherein like parts are designated with like reference numerals throughout. As used in this disclosure herein and throughout, the meaning of “a,” “an,” and “said,” includes plural reference unless the context clearly dictates otherwise. Also, as used in this disclosure herein, the meaning of “in” includes “into” and “on” unless the context clearly dictates otherwise.

As used herein, the term “about” in conjunction with numerals refers to a range of that numeral stating from 10% below the absolute of the numeral to 10% above the absolute of the numeral, inclusive.

Referring now to the figures, one or more exemplary embodiments of a universal mounting bracket device may be constructed from a rigid material such as plastic, rubber, or metal. In an exemplary embodiment, the rigid material is translucent so that when the LED strip is turned on the object displayed on the universal wall bracket is backlit. In another embodiment, the rigid material is substantially translucent. A person of reasonable skill in the art will be readily able to select a suitable construction material for the universal mounting bracket device based on the operation conditions and requirements.

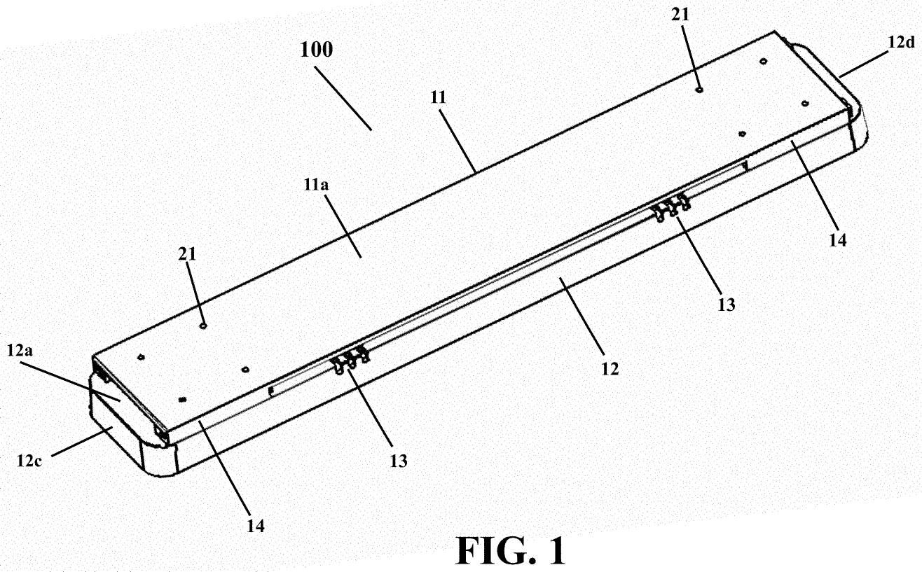

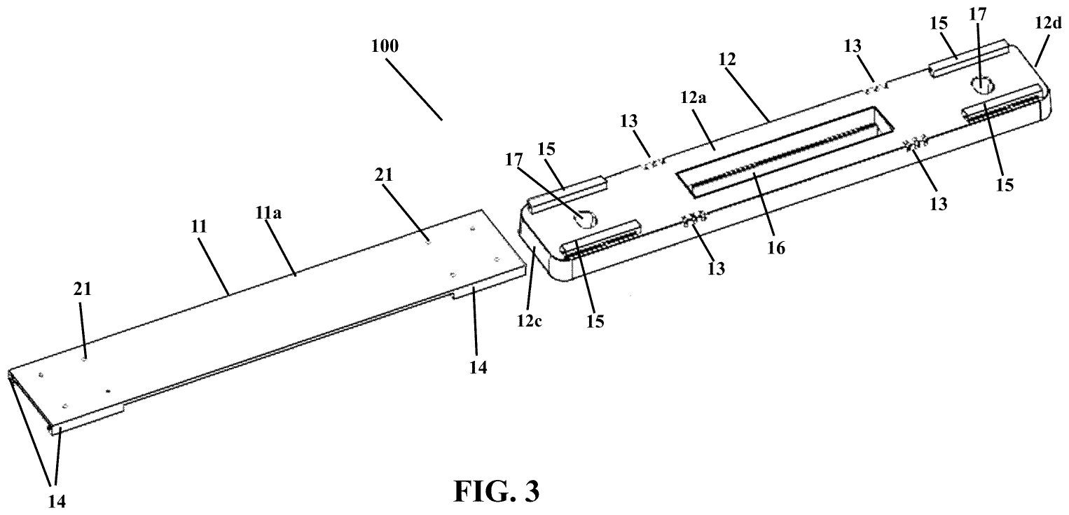

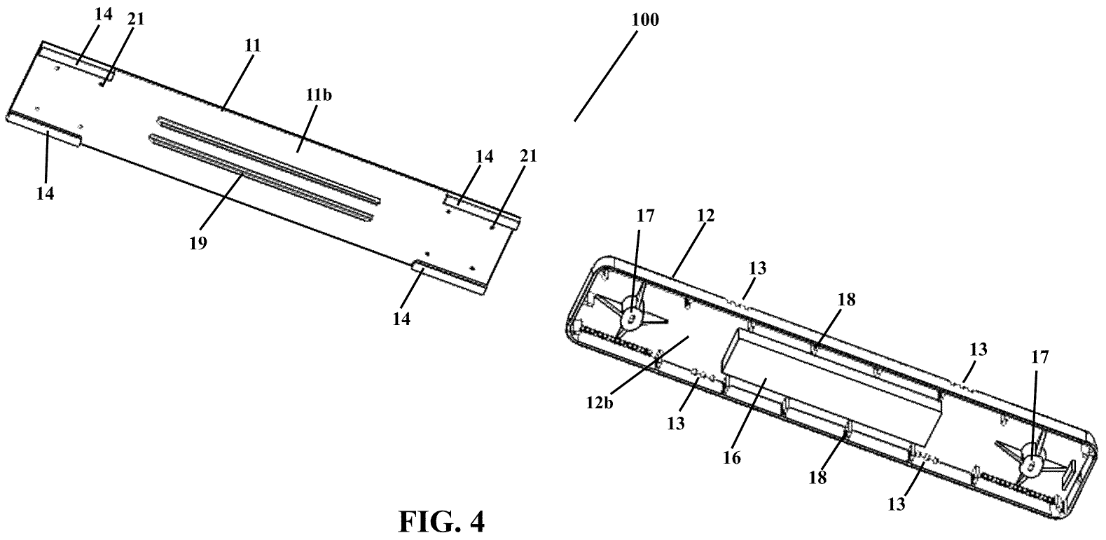

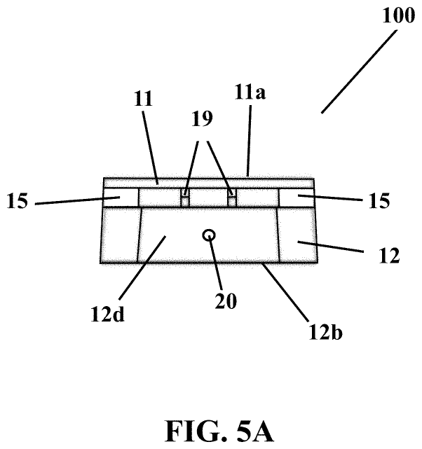

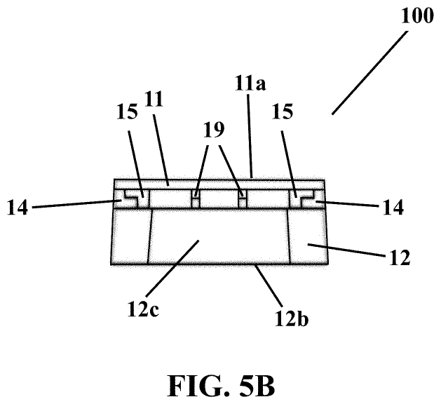

FIGS. 1-5 depict exemplary embodiments for universal mounting bracket device 100. In an embodiment, universal mounting bracket device 100 comprises mounting plate 11, wall bracket 12, plurality of vents 13, plurality of mounting plate slides 14, plurality of mounting plate clips 15, internal power source housing 16, a plurality of reinforced wall bracket holes 17, plurality of light housing tabs 18, at least one support tab 19, on/off switch 20, and a plurality of mounting plate holes 21.

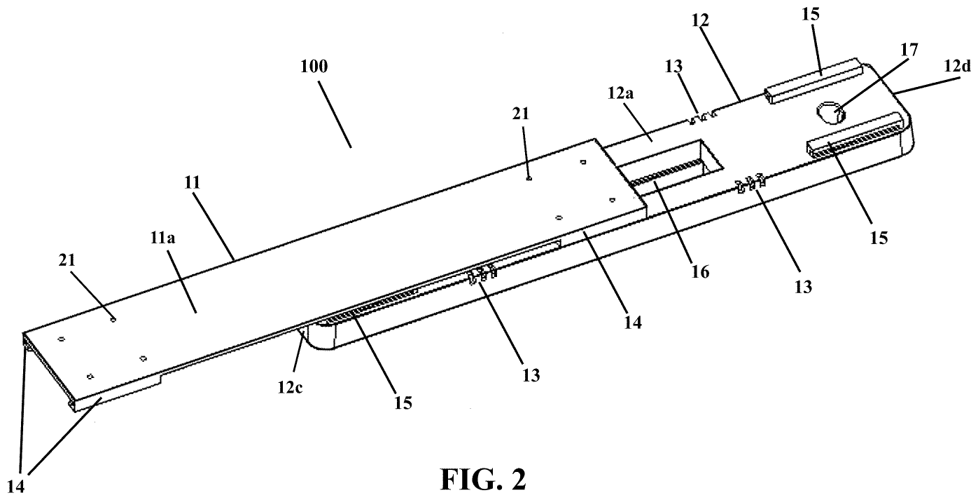

In one embodiment as depicted in FIG. 2, universal wall bracket 100 comprises a wall bracket 12 which comprises a top surface 12a and bottom surface 12b, front side 12c and back side 12d. In one embodiment, on/off switch 20 is configured to be on or off and is located on front side 12c of wall bracket 12. In an exemplary embodiment, on/off switch 20 is selected from the group consisting of a toggle switch, a slide switch, a rocker switch, and a push button switch.

In another embodiment, mounting plate 11 comprises top side 11a and bottom side llb, a plurality of mounting plate slides 14 protruding from bottom side 11b of mounting plate 11, wherein at least one support tab 19 protrudes from bottom side llb of mounting plate 11. In an embodiment, plurality of mounting plate clips 15 protrudes from top surface 12a of wall bracket 12, internal power source housing 16 protrudes from bottom surface 12b of wall bracket 12 and wherein internal power source housing 16 is open on top surface 12a of wall bracket 12 and closed on bottom surface 12b of wall bracket 12. In an embodiment, plurality of mounting paper clips 15 are located at each corner of wall bracket 12.

In one embodiment, plurality of reinforced wall bracket holes 17 are configured to allow a user to affix wall bracket 12 to a surface, and plurality of mounting plate slides 14 and plurality of mounting plate clips 15 are configured to allow a user to slide mounting plate 11 on and off of wall bracket 12. In another exemplary embodiment, plurality of mounting plate clips 15 are configured to be open at one end and closed on the opposite side such that mounting plate 11 may only be slid on or off of wall bracket 12 in one direction. In an embodiment, plurality of mounting plate slides 14 located at each corner of mounting plate 11.

In an embodiment, plurality of vents 13 are located on the edges of top surface 12a of wall bracket 12 to aid in cooling internal power source and LED lighting strip prevent heat damage from occurring to universal mounting bracket device 100.

In another embodiment, plurality of light housing tabs 18 are affixed along the edges of bottom surface 12b of wall bracket 12 and are configured to hold a strip of LED lights in place along bottom surface 12b of wall bracket 12. In another exemplary embodiment, universal mounting bracket device 100 is constructed of a translucent material to allow for strip of LED lighting, affixed to bottom surface 12b of wall bracket 12 via plurality of light housing tabs 18, to shine through the translucent material and backlight the object being displayed by universal mounting bracket device 100. In an embodiment, the translucent material comprises plastic, silicone, or other similar material that is rigid enough to support a loading bearing weight and also allow light to travel through it.

In this exemplary embodiment wall bracket 12 is affixed to a surface, via plurality of reinforced wall bracket holes 17, and mounting plate 11 is affixed to the object to be displayed, via the plurality of mounting plate holes 21. Mounting plate 11 is then affixed to wall bracket 12 via plurality of mounting plate slides 14 and plurality of mounting plate clips 15. In another exemplary embodiment, on/off switch 20 is used to turn on the strip of LED lights, that is affixed to bottom surface 12b of wall bracket 12, LED lights then backlight the object affixed to mounting plate 11.

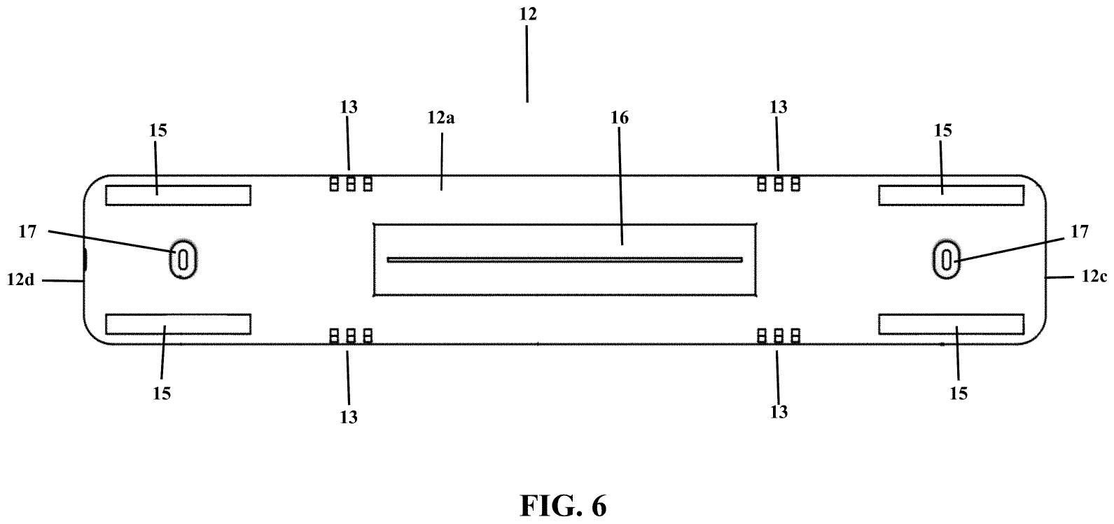

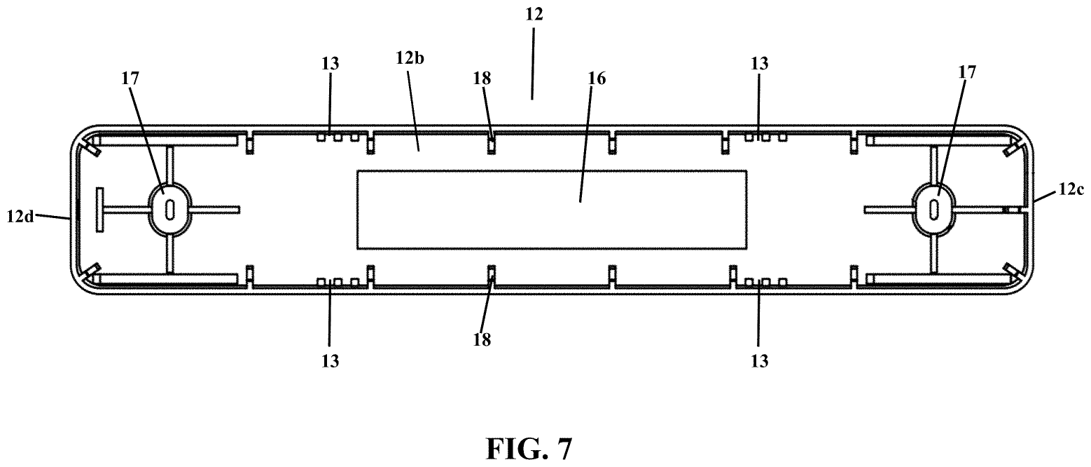

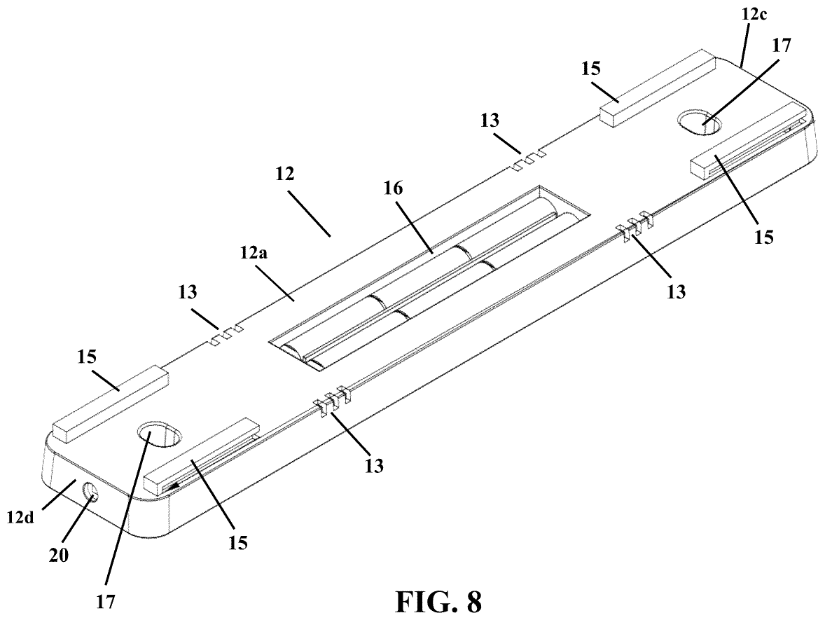

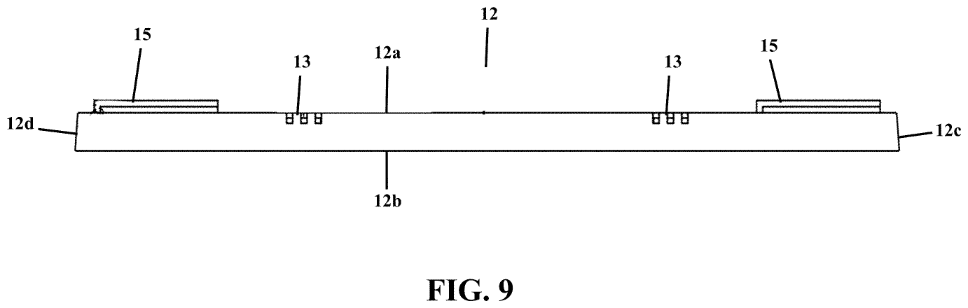

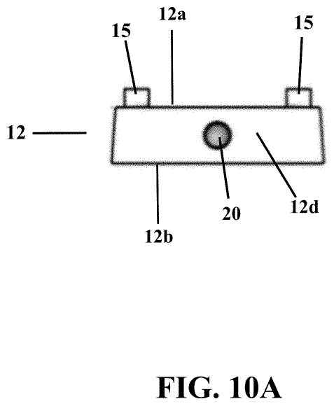

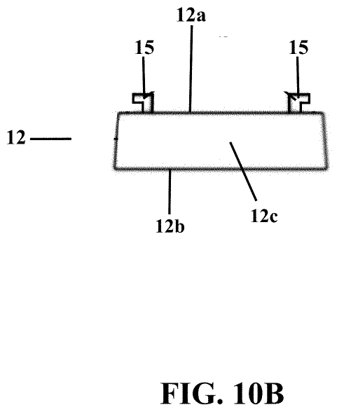

As shown in FIGS. 6-10, wall bracket 12 comprises a plurality of vents 13, a plurality of mounting plate clips 15 protruding from top surface 12a of wall bracket 12, an internal power source housing 16 protruding from bottom surface 12b of wall bracket 12 and is open on top surface 12a of wall bracket 12, a plurality of reinforced wall bracket holes 17 to allow a user to affix wall bracket 12 to a surface, a plurality of light housing tabs 18 affixed along the edges of bottom surface 12b of wall bracket 12, and an on/off switch 20 located on front side 12c of wall bracket 12. In this exemplary embodiment, plurality of vents 13 provides dissipation of heat caused by the internal or external power source used to supply power to turn on strip of LED lighting to prevent the object being displayed from being damaged by the internal or external power source.

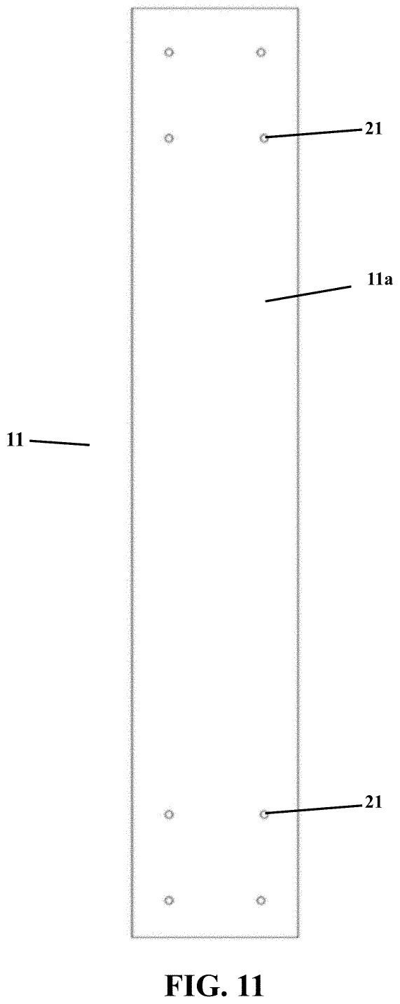

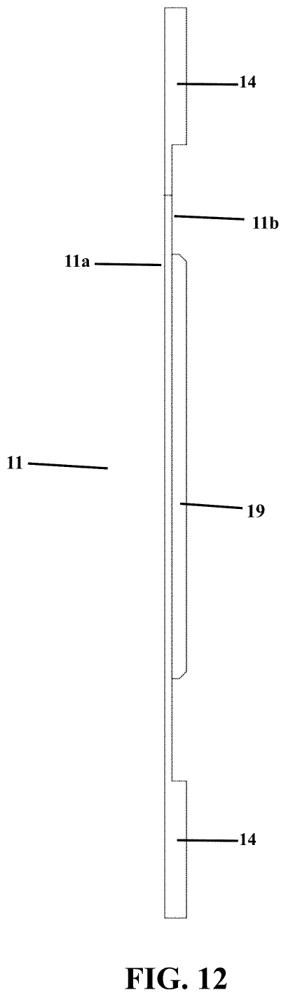

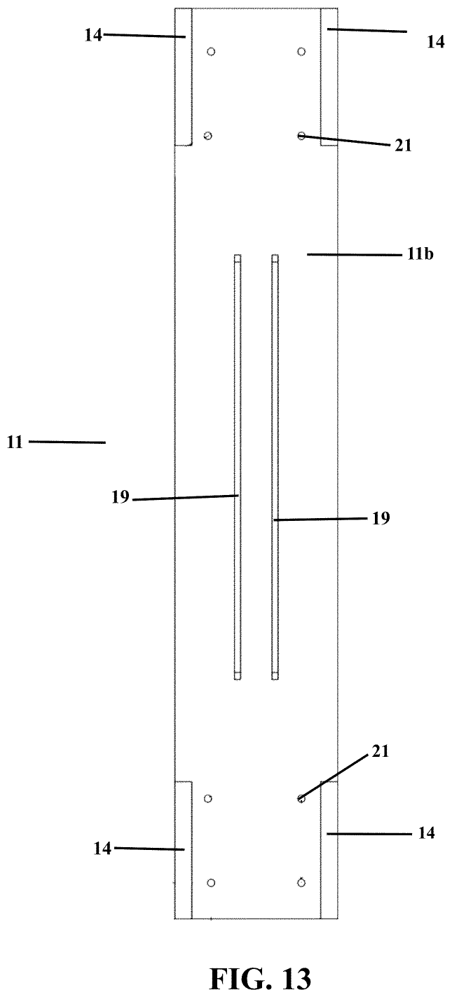

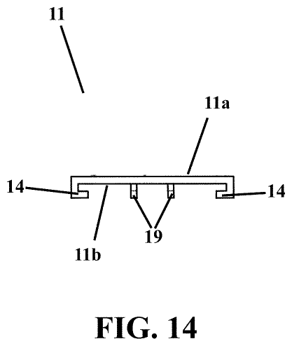

As shown in FIGS. 11-14, mounting plate 11 comprises a plurality of mounting plate slides 14 protruding from bottom side llb of mounting plate 11, and at least one support tab 19 protruding from bottom side 11b of mounting plate 11. In this exemplary embodiment, at least one support tab 19 provides support to universal mounting bracket device 100 to make it load bearing and at least one support tab 19 provides distance between the bottom side 11b of mounting bracket 11 and top surface 12a of wall bracket 12 to protect the object being displayed from any heat dissipation caused by the internal or external power source.

In an exemplary embodiment, the method for displaying an object on a surface comprises the steps of affixing wall bracket 12 to a surface via plurality of reinforced wall bracket holes 17; affixing an object to mounting plate 11 by via plurality of mounting plate holes 21; and sliding mounting plate 11 onto wall bracket 12 via plurality of mounting plate slides 14 and plurality of mounting plate clips 15.

Thus, specific embodiments of a universal mounting bracket device and methods to employ such device have been disclosed. It should be apparent, however, to those skilled in the art that may more modifications besides those already described are possible without departing from the inventive concepts herein. The inventive subject matter, therefore, is not to be restricted except in the spirit of the appended claims. Moreover, in interpreting both the specification and the claims, all terms are interpreted in the broadest possible manner consistent with the context. In particular the terms “comprises” and “comprising” should be interpreted as referring to elements, components, or steps in a non-exclusive manner, indicating that the reference elements, components, or steps may be present, or utilized, or combined with other elements, components, or steps that are not expressly referenced.

1. A universal mounting bracket device comprising:
a. a wall bracket comprising a top surface, a bottom surface, a front side, and a back side,
wherein:
i. said wall bracket is configured to be affixed to a surface;
ii. said wall bracket comprises a plurality of wall bracket holes; and
iii. said wall bracket comprises an on/off switch located on said front side of said wall bracket;
b. a mounting plate with a top side and a bottom side,
wherein:
i. said mounting plate is configured to allow an object to be affixed to said top side; and
ii. said mounting plate comprises a plurality of mounting plate holes;
c. a plurality of mounting plate clips protruding from said top surface of said wall bracket;
d. a plurality of mounting plate slides protruding from said bottom side of said mounting plate;
wherein said plurality of mounting plate clips and said plurality of mounting plate slides are configured to allow said mounting plate to affix to said wall bracket;
e. an internal power source housing protruding from said bottom surface of said wall bracket and is open on said top surface of said wall bracket;
f. a plurality of light housing tabs affixed along the edges of said bottom surface of said wall bracket,
wherein:
i. said plurality of light housing tabs are configured to hold in place a strip of LED lighting to provide back lighting to an object being displayed;
ii. said strip of LED lighting is powered by an internal power source; and
iii. said internal power source is affixed inside of said internal power source housing.

2. The universal mounting bracket device of claim 1, wherein said universal mounting bracket comprises a rigid material selected from the group consisting of plastic, rubber, silicone, metal, and any combination thereof

3. The universal mounting bracket device of claim 1, wherein said plurality of mounting plate clips are located at each corner of said wall bracket.

4. The universal mounting bracket device of claim 1, wherein said plurality of mounting plate slides are located at each corner of said mounting plate.

5. The universal mounting bracket device of claim 1, wherein said plurality of mounting plate clips are configured to be open at one side and closed on the opposite side such that when said mounting plate is slid onto said wall bracket said wall mounting plate can only be slid on or off of said wall bracket in one direction.

6. The universal mounting bracket device of claim 1, wherein said on/off switch is selected from the group consisting of a toggle switch, a slide switch, a rocker switch, and a push button switch.

7. The universal mounting bracket device of claim 1, wherein said wall bracket comprises a plurality of vents configured to allow for heat dissipation from said strip of LED lighting.

8. The universal mounting bracket device of claim 1, wherein said strip of LED lighting is capable of being powered by an internal power source or an external power source.

9. The universal mounting bracket device of claim 1, wherein said mounting plate comprises a plurality of support tabs protruding from said bottom side of said mounting plate to prevent said bottom side of said mounting plate from coming into contact with said top surface of said wall bracket.

10. The universal mounting bracket device of claim 1, wherein said mounting plate further comprises at least one support tab protruding from said bottom side of said mounting plate.

11. A universal mounting bracket device comprising:
a. a wall bracket with a top surface, a bottom surface, a front side, and a back side;
wherein:
i. said wall bracket is configured to be affixed to a surface;
ii. said wall bracket comprises a plurality of wall bracket holes;
b. a mounting plate with a top side and a bottom side;
wherein:
i. said mounting plate is configured to allow an object to be affixed to said top side;
ii. said mounting plate comprises a plurality of mounting plate holes;
c. a plurality of mounting plate clips protruding from said top surface of said wall bracket, wherein said plurality of mounting plate clips are located at each corner of said wall bracket;
d. a plurality of mounting plate slides protruding from said bottom side of said mounting plate, wherein said plurality of mounting plate slides are located at each corner of said mounting plate;
e. wherein said plurality of mounting plate clips and said plurality of mounting plate slides are configured to allow said mounting plate to affix to said wall bracket;
f. a plurality of light housing tabs along the edges of said bottom surface of said wall bracket; and
wherein:
i. said plurality of light housing tabs are configured to hold in place a strip of LED lighting to provide back lighting to an object being displayed; and
ii. said strip of LED lighting is powered by an external power source.

12. The universal mounting bracket device of claim 11, wherein said universal mounting bracket comprises a rigid material selected from the group consisting of plastic, rubber, silicone, metal, and any combination thereof.

13. The universal mounting bracket device of claim 11, wherein said plurality of mounting plate clips are configured to be open at one side and closed on the opposite side such that when said mounting plate may only be slid on or off of said wall bracket in one direction.

14. The universal mounting bracket device of claim 11, wherein said wall bracket comprises an on/off switch located on said front side of said wall bracket.

15. The universal bracket device of claim 14, wherein said on/off switch is selected from the group consisting of a toggle switch, a slide switch, a rocker switch, or a push button switch.

16. The universal mounting bracket device of claim 11, wherein said wall bracket comprises a plurality of vents configured to allow for heat dissipation from said strip of LED lighting.

17. The universal mounting bracket device of claim 11, wherein said strip of LED lighting is capable of being powered by an internal power source or an external power source.

18. The universal mounting bracket device of claim 11, wherein said mounting plate comprises a plurality of support tabs protruding from said bottom side of said mounting plate that prevent said bottom side of said mounting plate from coming into contact with said top surface of said wall bracket.

19. The universal mounting bracket device of claim 11, wherein said mounting plate comprises at least one support tab protruding from said bottom side of said mounting plate.

20. A method for displaying an object on a surface comprising:
a. affixing a wall bracket to a surface via a plurality of reinforced wall bracket holes;
wherein said wall bracket comprises:
i. a top surface and a bottom surface;
ii. a plurality of light housing tabs located on said bottom surface of said wall bracket configured for affixing a strip of LED lighting on said bottom surface of said wall bracket;
iii. a plurality of vents configured to dissipate heat caused by said strip of LED lighting, wherein said plurality of vents are located along the edges of said wall bracket;
iv. a plurality of mounting plate clips protruding from said bottom surface of said wall bracket and wherein said plurality of mounting plate clips are open at one side and closed at the other side;
b. affixing an object to a mounting plate by via a plurality of mounting plate holes; and
c. sliding said mounting plate onto said wall bracket via a plurality of mounting plate slides and a plurality of mounting plate clips,
wherein said mounting plate comprises:
i. a top side and a bottom side; and
ii. a plurality of mounting plate slides protruding from said bottom side of said mounting plate.
